(19) United States
(12) Patent Application Publication
(10) Pub. No.: US 2019/0065499 A1
(43) Pub. Date: Feb. 28, 2019

(54) Execution Planner

(71) Applicant: Bsquare Corp., Bellevue ;, WA (US)

(72) Inventors: David Wagstaff, Lake Forest, CA (US); Divya Krishnan, Kenmore, WA (US)

(21) Appl. No.: 16/114,145

(22) Filed: Aug. 27, 2018

Related U.S. Application Data
(60) Provisional application No. 62/550,832, filed on Aug. 28, 2017.

(51) Int. Cl. G06F 17/30; G06F 17/27

(52) U.S. Cl. CPC G06F 17/3043; G06F 17/277; G06F 17/30477; G06F 17/30398

(57) ABSTRACT

A system and method of receiving plain language questions and selecting the appropriate queries to execute in order to return a response to the questions. The system and method query expert users with proposed queries and datasets to allow the expert user to give the query context and make associations between the proper sources to develop a query that will give the correct answer. The query and associated data sets and context are stored for future use.

### CROSS-REFERENCE TO RELATED APPLICATIONS

This application claims benefit under 35 U.S.C. 119 to U.S. application Ser. No. 62/550,832 filed on Aug. 27, 2017, and incorporated herein by reference in its entirety.

### BACKGROUND

Existing data may not have programmatically defined associations between pieces of data. A computer system cannot make associations between things programmatically because it lacks context. This process is often done by an expert who uses information they may know intuitively to give context to the data. When a person makes these associations, that context is generally lost, so that work must be done again, and those associations must be rediscovered by each new user.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system for resolving routes to solve queries 100.

FIG. 2 illustrates an embodiment of a process for resolving routes to plan queries 200.

FIG. 3 illustrates an embodiment of a process for resolving routes to solve queries 300.

FIG. 4 illustrates an aspect of a system resolving routes to solve queries 400 in accordance with one embodiment.

FIG. 5 illustrates a system 500 in accordance with one embodiment.

### DETAILED DESCRIPTION

“Datastore” refers to a control memory structure, for example a database.

“Librarian” refers to logic to map queries and assertions onto the appropriate data source. For example (where an assertion may be a query or a fact): librarian(assertion){if(assertion requires immediate knowledge){ read sensor; } if(assertion is not immediate){ read historical data; } if(no permission to ask or assert){ return refusal; } }

Guided query development for experts to answer associative questions from non-experts utilizing previously un-contextualized datastores may utilize a combination of machine learning techniques, domain expertise, and iterative querying to develop execution plans to answer these questions. This allows the expert's contextual knowledge to be tracked, captured and retained by the system for future execution. Additionally the user experience of both a person asking a question or an expert answering the question is greatly improved. Efficiency is increased for the user and expert because they do not need to perform manual searches of numerous datastores to determine an answer to questions. Further, the contents of many of these datastores may not be linked to other contents in other datastores, thus making it very inefficient or even impossible to consider many factors to determine the proper answer to a user's question. Not only is efficiency increased for the current users, but future uses may also benefit from a larger datastore of linked expert knowledge.

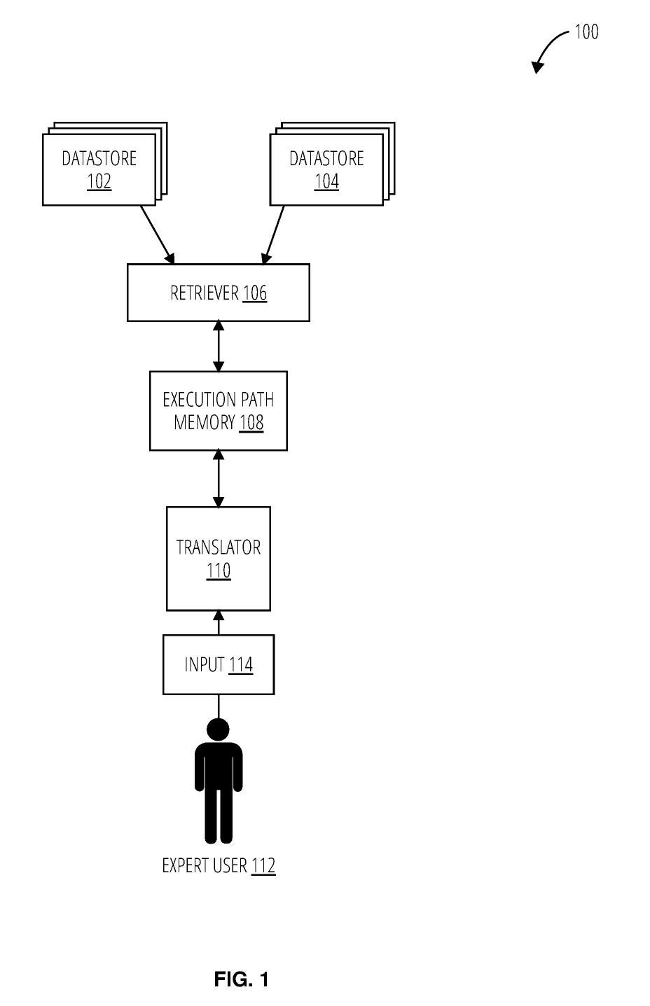

Referencing FIG. 1, the system for resolving routes to solve queries 100 comprises a datastore 102, a datastore 104, a retriever 106, an execution path memory 108, a translator 110, an expert user 112, and an input 114.

The expert user 112 may design the input 114, ant that input 114 may be sent to a translator 110 for translation for the associated systems and datastores. All translated queries may be retained by the execution path memory 108 to answer future questions if the translated queries have been shown to be correct. The retriever 106 is responsible for accessing the at least one datastore 102 and datastore 104 directly, and retrieving requested information.

There may be some instances where the questions are slightly different, but the end results are the same. The system may utilize a routine that is similar to voting, or utilize frequent path sets, to resolve conflicts between information from expert users. This may be shunted to a librarian module that is programmed to select between paths. Based on common similar queries, a common similar execution plan may be enacted.

Well known machine learning algorithms and techniques may be employed to help guide the expert at various stages. The machine may use techniques, such as frequent item sets, to draw out additional information from existing data to find data of which the expert may not be aware.

Execution Planner

The system has mainly two types of users—experts and non-experts. The non-experts are people who want to get answers from the system using subject matter expertise and data. They are usually the main source of generating new questions. The experts are involved in the initial setup and answering some of the initial questions asked by non-experts. The experts may have extensive domain and data knowledge, which helps them contextualize the data based on their experience.

Initial Setup

The first time the system is installed, all the data sources are connected and imported into system. The system may accept data in matrix form. And may import data as tables. Data sources from files, (for example, text or log files) may be converted to a single table. Each sheet of comma separated variables (csv) and EXCEL files may be converted into a table. At the end of the import, the system is expected to contain all structured data as tables.

Mapping

The second stage of the setup is the mapping between columns in the tables. To find the similarity between categorical columns, the EP may first find the distinct values for the two columns and then compare proportion of these distinct values. This will be computationally intensive as the number of tables and columns increase. Once similarity between two categorical columns is established, the EP may map the distribution of numeric columns between the tables to find similar numerical columns. The experts will have the option to accept these mappings or change these mappings. The experts can also add new mappings.

The other type of mapping is between words in the question and corresponding query that provides the answer for the question. For example, most may be by default mapped to ‘top 10’; expensive may be mapped to a cluster named ‘cost.’ The mapping may be between words or between words and data elements such as clusters.

Guided Query Development (GQD)

The Guided Query Development (GQD) for experts would be very similar to an SQL Server Management Studio Query environment. The GQD may suggest a family of tables based on the words entered for the query. For example, the query is—What are the most expensive repairs? In this scenario, the GQD looks for the family of ‘repair’ and maps the query words ‘most’ and ‘expensive’ to the ‘top 10’ and ‘cost’ columns. The initial query to the expert for the above question and mapping would be similar to:
Select top 10 <group by column>, sum(<cost column>) from Repair.<repairs-drop down to suggest all tables in the repair family> group by <group by column>

Then the expert may edit the query to answer this question. The expert may also add additional questions that can be posed back to the user. The first time the additional questions are posed by the expert, the additional questions are saved in the system. The next time a similar query is given by a non-expert, these additional questions may be asked immediately to get more information about the question and to help the expert contextualize the question. The questions, additional questions and the query corresponding to the question are linked and saved, such that the second time a non-expert has the same question, the answers can be obtained without any help from an expert.

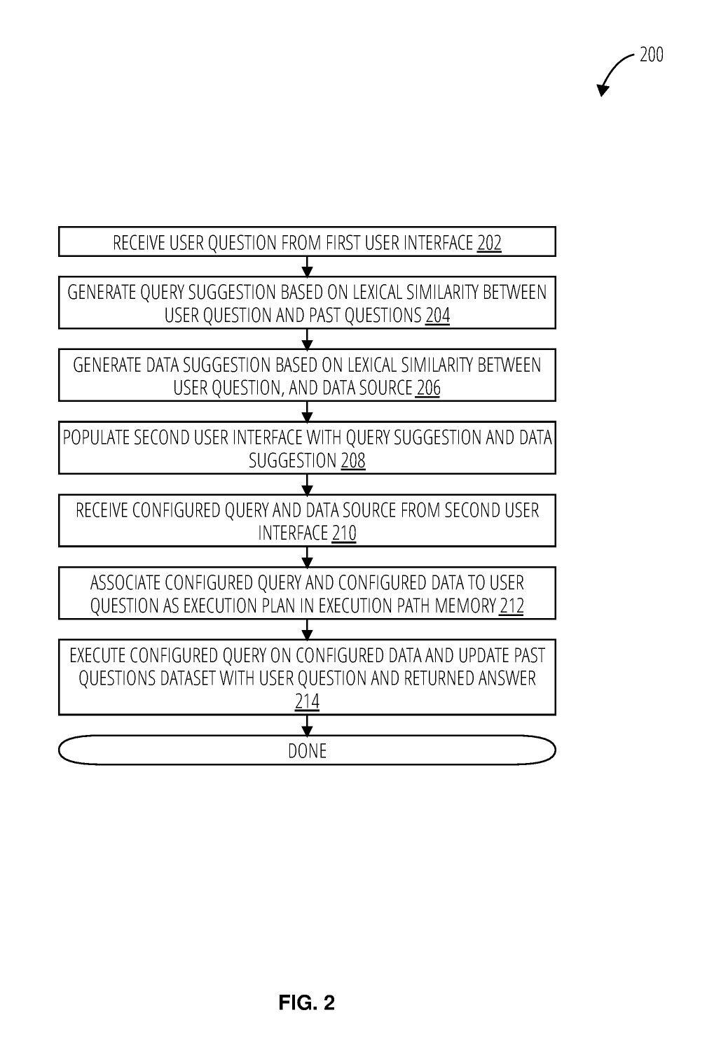

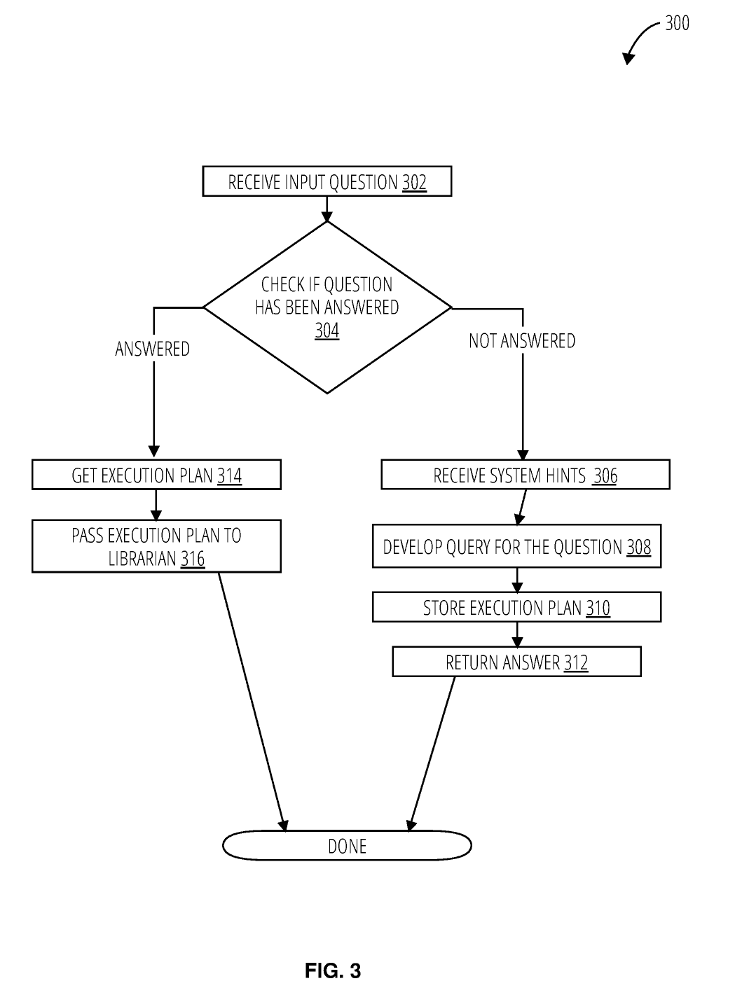

The system for resolving routes to solve queries 100 may be operated in accordance with the process described in FIG. 2 and FIG. 3.

Referencing FIG. 2, the process for resolving routes to plan queries 200 receives a user question from a first user interface (block 202). Next, the process 200 generates a query suggestion based on the lexical similarity between the user question and past questions (block 204). A data suggestion is then generate based on the lexical similarity between the user question and the data source (block 206). At least one second user interface may be populated with the query suggestion (block 208). The process 200 may further receive at least one configured query and at least one dataset from the at least one second user interface (block 210). An execution plan in an execution path memory may occur after associating the at least one configured query and at least one configured data to the user question (block 212). The process 200 may conclude by executing the at least one configured query on the at least one configured data, and updating a past questions dataset with the user question and the resulting answer (block 214).

A method may include receiving a user question from a first user interface; generating a query suggestion based on the lexical similarity between the user question and past questions; generating a data suggestion based on lexical similarity between the user question and a data source; populating at least one second user interface with the query suggestion and the data suggestion; receiving at least one configured query and at least one configured dataset from the at least one second user interface; associating the at least one configured query and at least one configured data to the user question as an execution plan in an execution path memory; executing the at least one configured query on the at least one configured data resulting in an answer; and updating the past questions dataset with the user question and the resulting answer.

The configured query may further comprise additional questions that can be posed back to the first user interface.

Receiving the configured query from the second user interface may further comprise receiving additional questions associated with the user question.

The system may also find possibly similar past questions to ask the expert if the current question is in fact similar. The system may also look for common data across the data sources to attempt to guide the expert to the correct query to answer the current question.

One of skill in the art will realize that the methods and apparatuses of this disclosure describe proscribed functionality associated with a specific, structured graphical interface. Specifically, the methods and apparatuses, inter alia, are directed to guided query development for experts to answer associative questions from non-experts utilizing previously un-contextualized datastores utilizing a combination of machine learning techniques, domain expertise, and iterative querying to develop execution plans to answer these questions. Interactive interfaces and methods may be used to facilitate capturing a user's question, transforming the question into a query suggestion and a database suggestion, allowing an expert to comment on the suggestions, associating the suggestions to the user question as an execution plan, executing the execution plan, and updating a prior questions dataset with the user question and the resulting answer. The methods and apparatuses allow the linking of different databases and questions that would not occur but for the knowledge of the experts and/or machine learning techniques. One of skill in the art will realize that these methods are significantly more than abstract data collection and manipulation.

Referencing FIG. 3, the process for resolving routes to solve queries 300 receives an input questions (block 302). The process 300 checks in an answer database to determine whether or not the input question has been answered in the past (decision block 304). If the question has been answered, the process 300 retrieves an execution plan (block 314) and passes the execution plan to the librarian (block 316).

If the question has not been answered, the process 300 receives system hints to the question (block 306). System hints may be the initial configuration process by the expert, by which the initial question is answered or elaborated on and answered. Receiving system hints may include using datastores with tables including categorical columns where a similarity between categorical columns in the same table or between different tables has been established. Next, the process 300 develops a query for the question (block 308). An execution plan may then be stored (block 310), followed by returning an answer and updating the answer database with the user question and the answer (block 312).

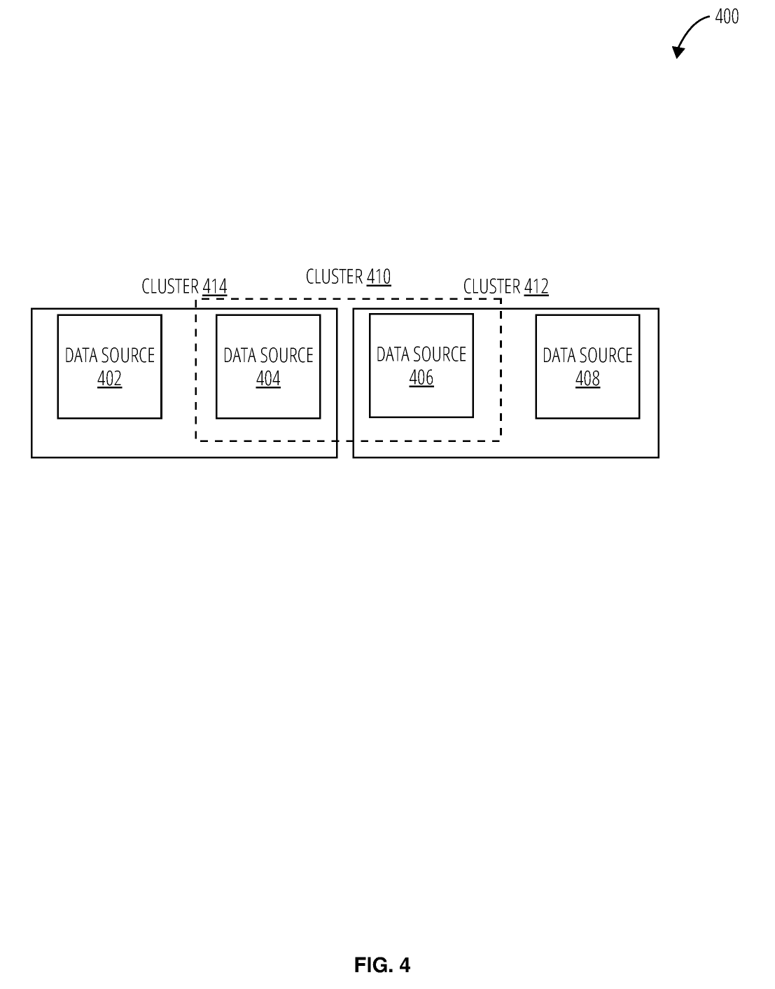

Referring to FIG. 4, a system for resolving routes to solve queries 400 comprises a cluster 410, a cluster 412, and a cluster 414. In an embodiment, the cluster 414 comprises the data source 402 and the data source 404, the cluster 410 comprises the data source 406 and the data source 404, and the cluster 412 comprises the data source 406 and the data source 408.

The data source 402 and the data source 404 may be grouped together in cluster 414 based on the lexical similarity between the contents of data source 402 and data source 404.

The data source 404 and the data source 406 may be grouped together in cluster 410 based on the lexical similarity between the contents of data source 406 and data source 404.

The data source 408 and the data source 406 may be grouped together in cluster 412 based on the lexical similarity between the contents of data source 406 and data source 408.

The system may perform text analytics on the table names to cluster similar table names based on common words or phrases in the table names. For example, consider tables RepairPart, RepairOrder, RepairDealer, RepairTruck. All the above tables would be grouped together into a cluster called ‘Repair.’ All the tables from the initial setup may be grouped into various clusters, with common words or phrases as the suggested name of the cluster. The tables without any common words or phrases may be grouped under the miscellaneous cluster. A table may be grouped under more than one cluster. The expert will have the option to accept the default names of the clusters or change the cluster name to context specific names. The expert may also regroup the tables by deleting a table from the cluster or dragging it into another cluster. When the table is deleted from a cluster, it may be added to the miscellaneous category.

The clustering and contextualization of the tables helps in guided query development. For instance, if a user performs a query about Repair, the experts may use ‘Repair’ in the query, and the EP shows all the tables under the Repair family of tables. This assists the experts in using all the tables that are in the context of Repair.

The system resolving routes to solve queries 400 may be operated in accordance with the process described in FIG. 2 and FIG. 3.

The methods and apparatuses provide a technological solution to a technological problem, and do not merely state the outcome or results of the solution. As an example, existing data may not have programmatically defined associations between pieces of data. A computer system cannot make associations between things programmatically because it lacks context. The solutions in this disclosure allow guided query development for experts to answer associative questions from non-experts utilizing previously un-contextualized datastores, and then use those answers to update the knowledge base. An expert's contextual knowledge can be tracked, captured and retained by the system for future execution. The solution leads to more efficient operation of the system by requiring fewer communications between the system and datastores, and by speeding up searches due to the prescreening of databases and eliminating those that may not be applicable to the search. This is a particular technological solution producing a technological and tangible result. The methods are directed to a specific technique that improves the relevant technology and are not merely a result or effect.

Additionally, the methods and apparatuses produce the useful, concrete, and tangible result of using an answer to a user's question to update the knowledge of past or present experts in datastores, and expanding the datastores with new links between different questions and their corresponding answers.

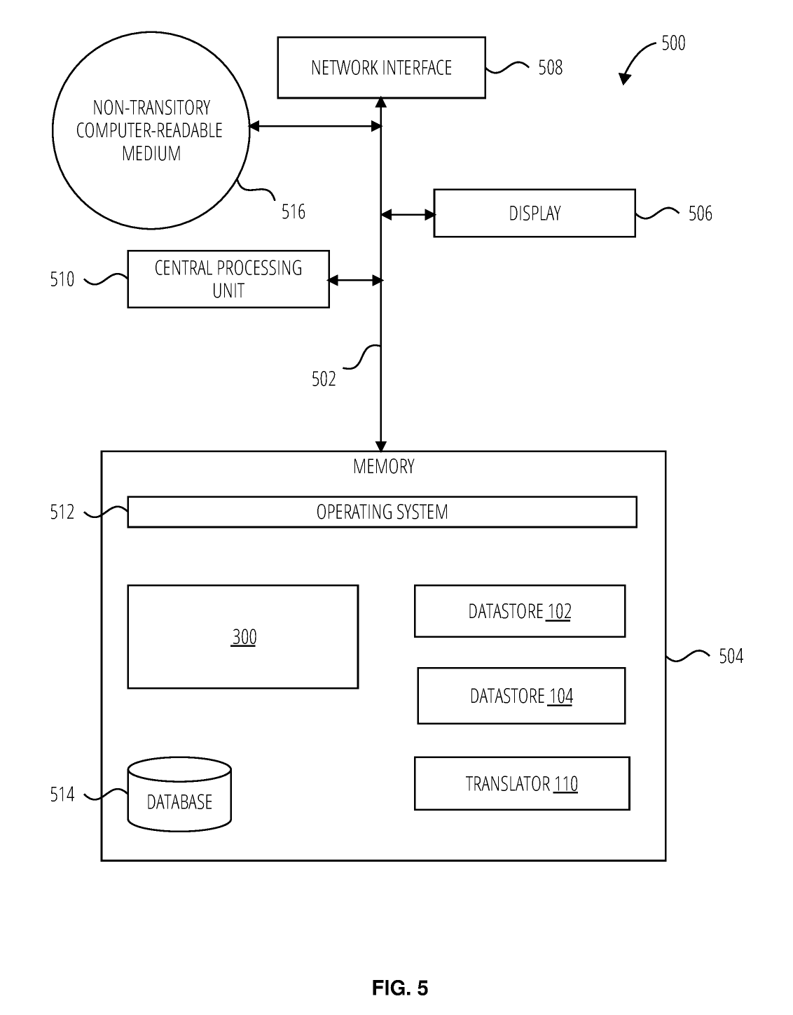

FIG. 5 illustrates several components of an exemplary system 500 in accordance with one embodiment. In various embodiments, system 500 may include a desktop PC, server, workstation, mobile phone, laptop, tablet, set-top box, appliance, or other computing device that is capable of performing operations such as those described herein. In some embodiments, system 500 may include many more components than those shown in FIG. 5. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 500 may comprise one or more physical and/or logical devices that collectively provide the functionalities described herein. In some embodiments, system 500 may comprise one or more replicated and/or distributed physical or logical devices.

In some embodiments, system 500 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 500 includes a bus 502 interconnecting several components including a network interface 508, a display 506, a central processing unit 510, and a memory 504.

Memory 504 generally comprises a random access memory (“RAM”) and permanent non-transitory mass storage device, such as a hard disk drive or solid-state drive. Memory 504 stores an operating system 512.

These and other software components may be loaded into memory 504 of system 500 using a drive mechanism (not shown) associated with a non-transitory computer-readable medium 516, such as a DVD/CD-ROM drive, memory card, network download, or the like.

Memory 504 also includes database 514. In some embodiments, system 500 may communicate with database 514 via network interface 508, a storage area network (“SAN”), a high-speed serial bus, and/or via the other suitable communication technology.

In some embodiments, database 514 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

Terms used herein should be accorded their ordinary meaning in the relevant arts, or the meaning indicated by their use in context, but if an express definition is provided, that meaning controls.

“Circuitry” refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” refers to software logic embodied as processor-executable instructions stored in read-only memories or media.

“Hardware” refers to logic embodied as analog or digital circuitry.

“Logic” refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Programmable device” refers to an integrated circuit designed to be configured and/or reconfigured after manufacturing. The term “programmable processor” is another name for a programmable device herein. Programmable devices may include programmable processors, such as field programmable gate arrays (FPGAs), configurable hardware logic (CHL), and/or any other type programmable devices. Configuration of the programmable device is generally specified using a computer code or data such as a hardware description language (HDL), such as for example Verilog, VHDL, or the like. A programmable device may include an array of programmable logic blocks and a hierarchy of reconfigurable interconnects that allow the programmable logic blocks to be coupled to each other according to the descriptions in the HDL code. Each of the programmable logic blocks may be configured to perform complex combinational functions, or merely simple logic gates, such as AND, and XOR logic blocks. In most FPGAs, logic blocks also include memory elements, which may be simple latches, flip-flops, hereinafter also referred to as “flops,” or more complex blocks of memory. Depending on the length of the interconnections between different logic blocks, signals may arrive at input terminals of the logic blocks at different times.

“Software” refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Those skilled in the art will recognize that it is common within the art to describe devices or processes in the fashion set forth herein, and thereafter use standard engineering practices to integrate such described devices or processes into larger systems. At least a portion of the devices or processes described herein can be integrated into a network processing system via a reasonable amount of experimentation. Various embodiments are described herein and presented by way of example and not limitation.

Those having skill in the art will appreciate that there are various logic implementations by which processes and/or systems described herein can be effected (e.g., hardware, software, or firmware), and that the preferred vehicle will vary with the context in which the processes are deployed. If an implementer determines that speed and accuracy are paramount, the implementer may opt for a hardware or firmware implementation; alternatively, if flexibility is paramount, the implementer may opt for a solely software implementation; or, yet again alternatively, the implementer may opt for some combination of hardware, software, or firmware. Hence, there are numerous possible implementations by which the processes described herein may be effected, none of which is inherently superior to the other in that any vehicle to be utilized is a choice dependent upon the context in which the implementation will be deployed and the specific concerns (e.g., speed, flexibility, or predictability) of the implementer, any of which may vary. Those skilled in the art will recognize that optical aspects of implementations may involve optically-oriented hardware, software, and or firmware.

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation.

The foregoing detailed description has set forth various embodiments of the devices or processes via the use of block diagrams, flowcharts, or examples. Insofar as such block diagrams, flowcharts, or examples contain one or more functions or operations, it will be understood as notorious by those within the art that each function or operation within such block diagrams, flowcharts, or examples can be implemented, individually or collectively, by a wide range of hardware, software, firmware, or virtually any combination thereof. Portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more processing devices (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

What is claimed is:

1. A method comprising:
receiving a user question from a first user interface;
generating a query suggestion based on lexical similarity between the user question and past questions, wherein the past questions are in a past questions dataset;
generating a dataset suggestion based on lexical similarity between the user question and a data source;
populating at least one second user interface with the query suggestion and the dataset suggestion;
receiving at least one configured query and at least one configured dataset from the at least one second user interface;
associating the at least one configured query and at least one configured dataset to the user question as an execution plan in an execution path memory;
executing the at least one configured query on the at least one configured dataset resulting in an answer; and
adding the answer and the user question to the past questions dataset.

2. The method of claim 1, wherein the at least one configured query comprises additional questions that can be posed back to the first user interface.

3. The method of claim 1, wherein receiving the at least one configured query from the at least one second user interface comprises receiving additional questions associated with the user question.

4. The method of claim 1, further comprising:
determining if there is at least one conflicting received configured query, wherein a conflicting received configured query is a query that conflicts with a different received at least one configured query;
providing a first operation configured to be performed based on a determination that there is at least one conflicting received configured query, wherein the first operation comprises:
deciding between the at least one conflicting received configured query and a different received at least one configured query to determine which query to associate with the at least one configured data, thereby creating a decided configured query;
associating the decided configured query and at least one configured dataset to the user question as an execution plan in an execution path memory;
executing the decided configured query on the at least one configured dataset resulting in an answer; and
adding the answer and the user question to the past questions dataset; and
providing a second operation configured to be performed based on a determination that there are no conflicting received configured queries, wherein the second operation comprises:
associating the at least one configured query and at least one configured dataset to the user question as an execution plan in an execution path memory;
executing the at least one configured query on the at least one configured dataset resulting in an answer; and
adding the answer and the user question to the past questions dataset.

5. The method of claim 4, wherein the deciding between the at least one conflicting received configured query includes utilizing frequent path sets.

6. The method of claim 1, wherein associating the at least one configured query and at least one configured dataset to the user question comprises using guided query development, including at least one of machine learning techniques, domain expertise, iterative querying, and combinations thereof.

7. The method of claim 1, wherein generating a dataset suggestion further comprises using data sources with tables including categorical columns, wherein a similarity between categorical columns in the same table or between different tables has been established.

8. The method of claim 7, wherein the similarity between the categorical columns is at least one of, similarity between words, similarity between words and clusters, and combinations thereof, wherein clusters are groups of tables resulting from performing text analytics on the names of the tables to cluster similar table names based on common words or phrases in the table names.

9. A method comprising:
receiving a user question;
determining if the user question has been answered in the past, wherein a question answered in the past is in an answered question database;
providing a first operation configured to be performed based on a determination that the question has been answered in the past, wherein the first operation comprises:
receiving an execution plan from a database, wherein the execution plan associates a query and a dataset to the user question; and
passing the execution plan to a librarian module, wherein upon execution of the librarian module, the librarian module executes the query on the dataset;
providing a second operation configured to be performed based on a determination that the question has not been answered in the past, wherein the second operation comprises:
receiving system hints, wherein the system hints are based on lexical similarity between the user question and datastores;
developing a query for the user question, wherein the query is based on lexical similarity between the user question and the system hints;
associating the query and system hints to the user question as an execution plan;
storing the execution plan;
executing the execution plan; and
adding the answer and the user question to the answered questions database, wherein the answer is the result of executing the execution plan.

10. The method of claim 9, wherein receiving system hints further comprises using datastores with tables including categorical columns, wherein a similarity between categorical columns in the same table or between different tables has been established.

11. The method of claim 10, wherein the similarity between the categorical columns is at least one of, similarity between words, similarity between words and clusters, and combinations thereof, wherein clusters are groups of tables resulting from performing text analytics on the names of the tables to cluster similar table names based on common words or phrases in the table names.

12. A computing apparatus, the computing apparatus comprising:
a processor; and
a memory storing instructions that, when executed by the processor, configure the apparatus to:
receive a user question from a first user interface;
generate a query suggestion based on lexical similarity between the user question and past questions, wherein the past questions are in a past questions dataset;
generate a dataset suggestion based on lexical similarity between the user question and a data source;
populate at least one second user interface with the query suggestion and the dataset suggestion;
receive at least one configured query and at least one configured dataset from the at least one second user interface;
associate the at least one configured query and at least one configured dataset to the user question as an execution plan in an execution path memory;
execute the at least one configured query on the at least one configured dataset resulting in an answer; and
add the answer and the user question to the past questions dataset.

13. The computing apparatus of claim 12, wherein the at least one configured query comprises additional questions that can be posed back to the first user interface.

14. The computing apparatus of claim 12, wherein receive the at least one configured query from the at least one second user interface comprises receiving additional questions associated with the user question.

15. The computing apparatus of claim 12, further comprising configure the apparatus to:
determine if there is at least one conflicting received configured query, wherein a conflicting received configured query is a query that conflicts with a different received at least one configured query;
provide a first operation configured to be performed based on a determination that there is at least one conflicting received configured query, wherein the first operation comprises:
deciding between the at least one conflicting received configured query and a different received at least one configured query to determine which query to associate with the at least one configured data, thereby creating a decided configured query;
associating the decided configured query and at least one configured dataset to the user question as an execution plan in an execution path memory;
executing the decided configured query on the at least one configured dataset resulting in an answer; and
adding the answer and the user question to the past questions dataset;
provide a second operation configured to be performed based on a determination that there are no conflicting received configured queries, wherein the second operation comprises:
associating the at least one configured query and at least one configured dataset to the user question as an execution plan in an execution path memory; and
executing the at least one configured query on the at least one configured dataset resulting in an answer; and
adding the answer and the user question to the past questions dataset.

16. The computing apparatus of claim 12, wherein the deciding between the at least one conflicting received configured query includes utilizing frequent path sets.

17. The computing apparatus of claim 12, wherein associating the at least one configured query and at least one configured data to the user question comprises using guided query development, including at least one of machine learning techniques, domain expertise, iterative querying, and combinations thereof.

18. The computing apparatus of claim 12, wherein generate a dataset suggestion further comprises using data sources with tables including categorical columns, wherein a similarity between categorical columns in the same table or between different tables has been established.

19. The computing apparatus of claim 18, wherein the similarity between the categorical columns is at least one of similarity between words, similarity between words and clusters, and combinations thereof, wherein clusters are groups of tables resulting from performing text analytics on the names of the tables to cluster similar table names based on common words or phrases in the table names.
